(19) United States
(12) Patent Application Publication
(10) Pub. No.: US 2008/0254898 A1
(43) Pub. Date: Oct. 16, 2008

(54) VIDEO GAME PROGRAM, VIDEO GAME DEVICE, AND VIDEO GAME CONTROL METHOD

(75) Inventor: Katsuyoshi Endo, Osaka (JP)

Correspondence Address: GLOBAL IP COUNSELORS, LLP, 1233 20TH STREET, NW, SUITE 700, WASHINGTON, DC, 20036-2680, US

(73) Assignee: KONAMI DIGITAL ENTERTAINMENT CO., LTD., Tokyo (JP)

(21) Appl. No.: 12/139,946

(22) Filed: Jun. 16, 2008

Related U.S. Application Data
(63) Continuation of application No. PCT/JP2006/321232, filed on Oct. 25, 2006.

(30) Foreign Application Priority Data
Dec. 26, 2005 (JP) 2005-372073

(51) Int. Cl. G06F 17/00; A63F 9/24

(52) U.S. Cl. 463/43; 463/32; 463/39

(57) ABSTRACT

In the present invention, the moving state data for setting a moving state of a moving object is recognized by a control unit. Acceleration data and time duration data, which are consecutively inputted into an input unit from a controller, are recognized by the control unit. Then, the position data of the controller is calculated by the control unit based on the acceleration data and the time duration data, both of which are recognized by the control unit. Then, displacement of the controller is calculated by the control unit based on the position data of the controller. Then, the moving state data is modified by the control unit depending on the displacement of the controller. Then, a moving state of the moving object is displayed on an image display unit with the image data corresponding to the moving object based on the modified moving state data.

### CROSS-REFERENCE TO THE RELATED APPLICATIONS

This application claims priority to Japanese Patent Application No. 2005-372073 and International Patent Application No. PCT/JP2006/321232. The entire disclosure of Japanese Patent Application No. 2005-372073 and International Patent Application No. PCT/JP2006/321232 is hereby incorporated herein by reference.

### BACKGROUND OF THE INVENTION

1. Technical Field

The preset invention relates to a video game program, particularly to a video game program for causing a computer to realize a video game in which a moving object is displayed on an image display unit and a moving state of the moving object is controlled based on the acceleration data detected by an acceleration sensor when a controller in which the acceleration sensor is embedded is moved. Also, the present invention relates to a video game device that is capable of executing the video game to be realized by the video game program, and relates to a video game control method for allowing a computer to control the video game to be realized by the video game program.

2. Background Art

Various video games have been proposed in the past. The video games are configured to be executed in a game device. For example, a general game device includes a monitor, a game console that is provided separately from the monitor, and an input unit (e.g., a controller) that is provided separately from the game console. An input part (e.g., a plurality of input buttons) is disposed on the controller. A game device of this type is configured to be capable of causing an object displayed on the monitor to perform an action by manipulating the input buttons.

A situation is hereinafter considered that a versus-type game (e.g., baseball game) is executed in a game device of this type. In the baseball game, it is possible to cause a pitcher character to pitch a ball by manipulating input buttons of a controller. JIKKYOU PAWAFURU PURO YAKYU 9 KETTEIBAN, Konami Corporation, for PS2 discloses such game, as an example. In the baseball game, when a variety of instructions are given to the pitcher character, first, a pitch with which the pitcher character is caused to release a ball is selected by pressing up, down, left, and right portions of a cross-shaped button. Next, a pitching motion of the pitcher character is started by pressing an X button. Subsequently, while the pitcher character performs a pitching motion, the ball velocity is increased by repeatedly pressing the X button, and a pitching course of a ball is selected by pressing the up, down, left, and right portions of the cross-shaped button. Then, a ball is released by the pitcher character after a predetermined period of time is elapsed. Accordingly, a state that the ball released by the pitcher character moves at the predetermined ball velocity that is increased while it changes at the constant changing amount of the selected pitch is displayed on the monitor.

### SUMMARY OF THE INVENTION

In the conventional baseball game, a state that a ball released by a pitcher character moves at the selected predetermined ball velocity (or speed) while it changes at the constant changing amount of a selected pitch is configured to be displayed on a monitor. However, as to a ball released by a pitcher in the real baseball, the changing amount and the velocity of a ball changes depending on a pitching style of a pitcher. For example, under a condition that a right-handed pitcher tries to throw a curveball, an extent to which a ball changes becomes greater as swing of the pitcher's arm from right to left gets bigger when the swing is seen from the pitcher, and the ball velocity becomes greater as swing of the pitcher's arm from top to bottom becomes bigger when the swing is seen from the pitcher. For the purpose of realizing the actual relation between the pitching motion of a pitcher and the changing amount and the velocity of a ball in the conventional baseball game, it is necessary to evaluate the changing amount of a ball and the velocity of a ball, which correspond to the pitching motion of a pitcher, based on the input data from a controller. However, the conventional baseball game could not evaluate the changing amount and the velocity of a ball based on the input data from the controller. Therefore, it has been difficult to cause the changing amount of a ball and the velocity of a ball to change depending on the pitching motion of a pitcher.

An object of the present invention is to make it possible that an object such as a ball character is displayed on an image display unit and a moving state of the object such as the ball character is controlled based on the acceleration data detected by an acceleration sensor when a controller in which the acceleration sensor is embedded is moved.

A video game program in accordance with a first aspect of the present invention causes a computer, which is configured to be capable of realizing a video game in which a moving object is displayed on an image display unit and a moving state of the moving object is controlled based on the acceleration data detected by an acceleration sensor when a controller in which the acceleration sensor is embedded is moved, to realize the following functions.

(1) A moving state data recognizing function for causing a control unit to recognize the moving state data for setting the moving state of the moving object.

(2) An acceleration data recognizing function for causing the control unit to recognize the acceleration data to be consecutively inputted into an input unit from the controller.

(3) A time duration data recognizing function for causing the control unit to recognize time duration of the acceleration data to be consecutively inputted into the input unit from the controller as the time duration data.

(4) A position data calculating function for causing the control unit to calculate at least either the position data of the controller or the angle data of the controller based on the acceleration data and the time duration data, both of which are recognized by the control unit.

(5) A changing amount calculating function for causing the control unit to calculate the changing amount of the controller based on at least either the position data of the controller or the angle data of the controller.

(6) A moving state data modifying function for causing the control unit to modify the moving state data depending on the changing amount of the controller.

(7) A moving object displaying function for displaying the moving state of the moving object on the image display unit with the image data corresponding to the moving object based on the modified moving state data.

According to the game to be realized by the program, in the moving state data recognizing function, the moving state data for setting the moving state of the moving object is recognized by the control unit. In the acceleration data recognizing function, the acceleration data to be consecutively inputted into the input unit from the controller is recognized by the control unit. In the time duration data recognizing function, time duration of the acceleration data to be consecutively inputted into the input unit from the controller is recognized by the control unit as the time duration data. In the position data calculating function, at least either the position data of the controller or the angle data of the controller is calculated by the control unit based on the acceleration data and the time duration data, both of which are recognized by the control unit. In the changing amount calculating function, the changing amount of the controller is calculated by the control unit based on at least either the position data of the controller or the angle data of the controller. In the moving state data modifying function, the moving state data is modified by the control unit depending on the changing amount of the controller. In the moving object displaying function, the moving state of the moving object is displayed on the image display unit with the image data corresponding to the moving object based on the modified moving state data.

In an example of a baseball game to be realized by the game program, when a pitch is selected, the moving state data for setting a moving state of a ball character is recognized by the control unit. Then, when a game player holding the controller in which the acceleration sensor is embedded with his/her hand performs a throwing motion as if he/she were a pitcher, the acceleration data and the time duration data, both of which are consecutively inputted into the input unit from the controller, are recognized by the control unit. Accordingly, at least either the position data of the controller or the angle data of the controller is calculated by the control unit based on the acceleration data and the time duration data, both of which are recognized by the control unit. Then, the changing amount of the controller is calculated by the control unit based on at least either the position data of the controller or the angle data of the controller. Accordingly, the moving state data of the ball character to be released by a pitcher character is modified by the control unit depending on the changing amount of the controller. Accordingly, a moving state of the ball is displayed on the image display unit with the image data corresponding to the ball based on the modified moving state data of the ball.

In the game program, it is possible to change a moving state of the ball character to be released when a game player performs a throwing motion as if he/she were a pitcher while he/she holds the controller with his/her hand. In other words, it is possible to control movement of the object such as the ball character based on the acceleration data inputted into the controller by moving the controller in which the acceleration sensor is embedded.

A video game program in accordance with a second aspect of the present invention is the game program of the first aspect, and the moving velocity data for setting the moving velocity of the moving object is modified by the control unit depending on the changing amount of the controller. This function is realized by the moving state data modifying function.

In this case, in the moving state data modifying function, the moving velocity data for setting the moving velocity of the moving object is configured to be modified by the control unit depending on the changing amount of the controller. Therefore, it is possible to change the moving velocity of the moving object depending on the changing amount of the controller when a game player moves the controller while he/she holds the controller with his/her hand. For example, in the baseball game, when a game player performs a throwing motion as if he/she were a pitcher while he/she holds the controller with his/her hand, it is possible to change the moving velocity of the released ball depending on the changing amount of the controller.

A video game program in accordance with a third aspect of the present invention is the game program of the second aspect, and the moving velocity data for setting the moving velocity of the moving object is modified by the control unit depending on the vertical displacement of the controller. This function is realized by the moving state data modifying function.

In this case, in the moving state data modifying function, the moving velocity data for setting the moving velocity of the moving object is configured to be modified by the control unit depending on the vertical displacement of the controller. Therefore, when a game player moves the controller while he/she holds the controller with his/her hand, it is possible to change the moving velocity of the moving object depending on the vertical displacement of the controller. For example, in the baseball game, when a game player performs a throwing motion as if he/she were a pitcher while he/she holds the controller with his/her hand, it is possible to change the moving velocity of the released ball depending on the vertical displacement of the controller.

A video game program in accordance with a fourth aspect of the present invention is the video game program of the first aspect, and the changing amount data for setting the changing amount of the moving object is modified by the control unit depending on the changing amount of the controller. This function is realized by the moving state data modifying function.

In this case, in the moving state data modifying function, the changing amount data for setting the changing amount of the moving object is configured to be modified by the control unit depending on the changing amount of the controller. Therefore, when a game player moves the controller while he/she holds the controller with his/her hand, it is possible to change the changing amount of the moving object depending on the changing amount of the controller. For example, in the baseball game, when a game player performs a throwing motion as if he/she were a pitcher while he/she holds the controller with his/her hand, it is possible to change the changing amount of the released ball depending on the changing amount of the controller.

A video game program in accordance with a fifth aspect of the present invention is the video game program of the fourth aspect, and the changing amount data for setting the changing amount of the moving object is modified by the control unit depending on the displacement of the controller in a crossover direction to the vertical direction. This function is realized by the moving state data modifying function.

In this case, in the moving state data modifying function, the changing amount data for setting the changing amount of the moving object is configured to be modified by the control unit depending on the displacement of the controller in a crossover direction to the vertical direction. Therefore, when a game player moves the controller while he/she holds the controller with his/her hand, it is possible to change the displacement of the moving object depending on the displacement of the controller in a crossover direction to the vertical direction. For example, in the baseball game, when a game player performs a throwing motion as if he/she were a pitcher while he/she holds the controller with his/her hand, it is possible to change the changing amount of the released ball depending on the horizontal displacement of the controller.

A video game program in accordance with a sixth aspect of the present invention is the video game program of the fourth aspect, and the changing amount data for setting the changing amount of the moving object is modified by the control unit depending on the rotation amount of the controller. This function is realized by the moving state data modifying function.

In this case, in the moving state data modifying function, the changing amount data for setting the changing amount of the moving object is configured to be modified by the control unit depending on the rotation amount of the controller. Therefore, when a game player rotationally moves the controller while he/she holds the controller with his/her hand, it is possible to change the displacement of the moving object depending on the rotation amount of the controller. For example, in the baseball game, when a game player performs a throwing motion as if he/she were a pitcher while he/she holds the controller with his/her hand, it is possible to change the changing amount of the released ball depending on the rotation amount of the controller during the throwing motion.

A video game program in accordance with a seventh aspect of the present invention is the video game program of the first aspect, and the following function is further realized.

(8) A time elapse judging function for causing the control unit to judge whether or not a predetermined period of time is elapsed from the recognition starting time of the acceleration data recognized by the control unit.

According to the game to be realized by the program, in the time elapse judging function, it is judged by the control unit whether or not a predetermined period of time is elapsed from the recognition starting time of the acceleration data recognized by the control unit. Then, in the position data calculating function, at least either the position data of the controller or the angle data of the controller is calculated by the control unit based on the acceleration data and the time duration data, both of which are recognized by the control unit, when it is judged by the control unit that the predetermined period of time is elapsed.

In this case, in the position data calculating function, at least either the position data of the controller or the angle data of the controller is configured to be calculated by the control unit based on the acceleration data and the time duration data, both of which are recognized by the control unit when it is judged by the control unit that a predetermined period of time is elapsed. Accordingly, in the baseball game for instance, when a game player performs a throwing motion as if he/she were a pitcher while he/she holds the controller with his/her right hand, at least either the position data of the controller or the angle data of the controller is calculated by the control unit based on the acceleration data and the time duration data, both of which are obtained in a period of time in which the pitcher character starts a pitching motion and then a ball is released. It is possible to change the moving state of the released ball depending on the changing amount of the controller during a pitching motion by calculating the changing amount of the controller based on the data.

A video game device in accordance with a eighth aspect of the present invention is a video game device that is configured to be capable of executing a video game in which a moving object is displayed on an image display unit and a moving state of the moving object is controlled based on the acceleration data detected by an acceleration sensor when a controller in which the acceleration sensor is embedded is moved. The video game device includes moving state data recognizing means for causing a control unit to recognize the moving state data for setting the moving state of the moving object, acceleration data recognizing means for causing the control unit to recognize the acceleration data to be consecutively inputted into an input unit from the controller, time duration data recognizing means for causing the control unit to recognize time duration of the acceleration data to be consecutively inputted into the input unit from the controller as the time duration data, position data calculating means for causing the control unit to calculate at least either the position data of the controller or the angle data of the controller based on the acceleration data and the time duration data, both of which are recognized by the control unit, changing amount calculating means for causing the control unit to calculate the changing amount of the controller based on at least either the position data of the controller or the angle data of the controller, moving state data modifying means for causing the control unit to modify the moving state data depending on the changing amount of the controller, and moving object displaying means for displaying the moving state of the moving object on the image display unit with the image data corresponding to the moving object based on the modified moving state data.

A video game control method in accordance with a ninth aspect of the present invention is a video game control method that is for controlling a video game in which a moving object is displayed on an image display unit and a moving state of the moving object is controlled based on the acceleration data detected by an acceleration sensor when a controller in which the acceleration sensor is embedded is moved. The video game control method includes recognizing moving state of the moving object displayed on an image display unit, recognizing acceleration of the input unit, recognizing time duration of the acceleration, calculating either a position of the input unit or an angle of the input unit based on the acceleration and the time duration, calculating change of the position of the input unit on the basis of either the position or the angle of the input unit, modifying the moving state to modified moving state on the basis of the change, and displaying the moving object on the image display unit on the basis of the modified moving state.

### BRIEF DESCRIPTION OF THE DRAWINGS

Referring now to the attached drawings which form a part of this original disclosure.

FIG. 1 is a basic configuration diagram of a video game device in accordance with an embodiment of the present invention.

FIG. 2 is a functional block diagram as an example of the video game device.

FIG. 3 is a diagram for illustrating correspondence between a moving state of a controller and a position of a mitt of a catcher character.

FIG. 4 is a diagram for illustrating correspondence between a moving state of the controller and a pitcher character.

FIG. 5 is a diagram for illustrating relation among the acceleration data, the velocity data, and the position data.

FIG. 6 is a diagram for illustrating a method of calculating displacement of the controller.

FIG. 7 is a diagram for illustrating tables to be used for the calculation of moving velocity and displacement.

FIG. 8 is a flowchart for illustrating a control system of a pitched ball.

FIG. 9 is a flowchart for illustrating the control system of the pitched ball.

FIG. 10 is a diagram for illustrating an axis of rotation of a controller in accordance with another embodiment.

FIG. 11 is a diagram for illustrating a table to be used for the calculation of displacement.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### Configuration and Operation of Game Device

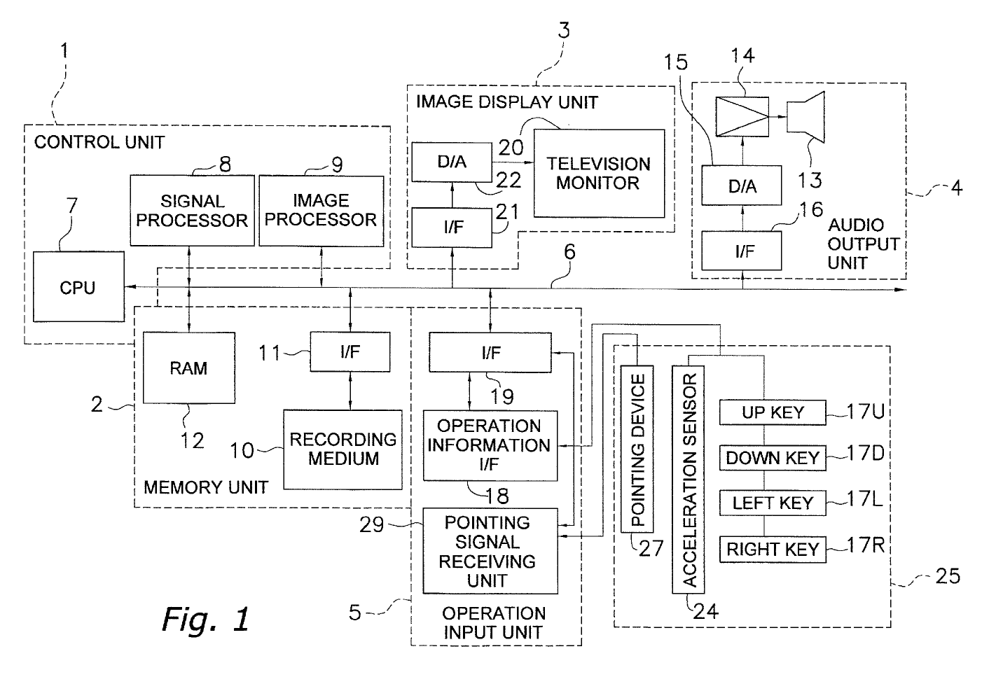

FIG. 1 shows the basic configuration of a game device in accordance with an embodiment of the present invention. As an example of a video game device, a home video game device will be hereinafter explained. The home video game device includes a home video game console and a home television set. A recording medium 10 is configured to be allowed to be loaded in the home video game console. Game data is arbitrarily read out of the recording medium 10 and a game is executed. The content of the game executed herewith is displayed on the home television set.

The game system of the home video game device is made up of a control unit 1, a memory unit 2, an image display unit 3, an audio output unit 4, an operation input unit 5, and a controller 25, and these units are connected to each other through a bus 6. This bus 6 includes an address bus, a data bus, a control bus, and the like. Here, the control unit 1, the memory unit 2, the audio output unit 4, and the operation input unit 5 are included in the home video game console of the home video game device, and the image display unit 3 is included in the home television set.

The control unit 1 is provided for mainly controlling progress of the entire game based on the game program. The control unit 1 is made up of a CPU (Central Processing Unit) 7, a signal processor 8, and an image processor 9, for instance. The CPU 7, the signal processor 8, and the image processor 9 are connected to each other through the bus 6. The CPU 7 interprets a command from a game program and performs a variety of data processing and data control. For example, the CPU 7 commands the signal processor 8 to provide the image data to the image processor. The signal processor 8 mainly performs computations in the three-dimensional space, computations of positional conversion from the three-dimensional space to the virtual three-dimensional space, a light source computation processing, and data generation and data processing of the image data and the audio data. The image processor 9 mainly performs a processing to write the image data to be rendered to a RAM 12 based on the computation results and processing results of the signal processor 8.

The memory unit 2 is provided mainly for storing the program data, various types of data used for the program data, and the like. The memory unit 2 is made up of the recording medium 10, an interface circuit 11, and the RAM (Random Access Memory) 12, for instance. The interface circuit 11 is connected to the recording medium 10. The interface circuit 11 and the RAM 12 are connected through the bus 6. The recording medium 10 serves to store the program data of the operating system, the game data made up of the image data, the audio data, various types of program data, and the like. For example, this recording medium 10 is a ROM (Read Only Memory) cassette, an optical disk, a flexible disk, or the like. The program data of the operating system, the game data, and the like are stored in this recording medium 10. Note that a card memory is also included in the category of the recording medium 10 and is mainly used for storing various game parameters at the point of interruption when the game is interrupted. The RAM 12 is used for temporarily storing various types of data read out of the recording medium 10, and for temporarily recording the processing results from the control unit 1. In addition to various types of data, the address data indicating the memory location of various types of data is stored in the RAM 12, and it is configured to be allowed to specify an arbitrary address and read/write data from/to the address.

The image display unit 3 is provided for mainly outputting the image data written to the RAM 12 by the image processor 9, the image data to be read out of the recording medium 10, and the like, as an image. The image display unit 3 is made up of a television monitor 20, an interface circuit 21, and a D/A converter (Digital-to-Analog converter) 22, for instance. The D/A converter 22 is connected to the television monitor 20, and the interface circuit 21 is connected to the D/A converter 22. In addition, the bus 6 is connected to the interface circuit 21. Here, the image data is provided to the D/A converter 22 through the interface circuit 21, and is herein converted into an analog image signal. Then, the analog image signal is outputted to the television monitor 20 as an image.

Here, the image data includes the polygon data, the texture data, and the like, for instance. The polygon data is the coordinate data of apexes forming the polygon. The texture data is used for setting texture with respect to the polygon, and is made up of the texture specifying data and the texture color data. The texture specifying data is the data for associating the polygon and the texture, and the texture color data is the data for specifying the texture color. Here, the polygon address data and the texture address data, both of which indicate the memory location of each type of data, are associated with the polygon data and the texture data, respectively. With the image data of this type, the coordinate conversion and the perspective projection conversion are performed with respect to the polygon data in the three-dimensional space (i.e., the three-dimensional polygon data) indicated with the polygon address data by the signal processor 8, based on the displacement data and the rotational data of the screen itself (i.e., point of sight). Accordingly, the polygon data is converted into the polygon data in the two-dimensional space (i.e., the two-dimensional polygon data). Then, a polygon outline is constituted with a plurality of two-dimensional polygon data, and the texture data specified by the texture address data is written to the internal area of the polygon. Thus, it is possible to express objects made by applying texture to each polygon, that is, various characters.

The audio output unit 4 is provided mainly for outputting the audio data to be read out of the recording medium 10 as the audio. The audio output unit 4 is made up of a speaker 13, an amplifier circuit 14, a D/A converter 15, and an interface circuit 16, for instance. The amplifier circuit 14 is connected to the speaker 13. The D/A converter 15 is connected to the amplifier circuit 14. The interface circuit 16 is connected to the D/A converter 15. In addition, the bus 6 is connected to the interface circuit 16. Here, the audio data is provided to the D/A converter 15 through the interface circuit 16 and is herein converted into an analog audio signal. The analog audio signal is amplified by the amplifier circuit 14 and is outputted from the speaker 13 as the audio. ADPCM (Adaptive Differential Pulse Code Modulation) data, PCM (Pulse Code Modulation) data, and the like are included in the category of the audio data, for instance. In the case of the ADPCM data, it is possible to output the audio from the speaker 13 with almost the same type of processing method as described above. In the case of the PCM data, it is possible to output the audio from the speaker 13 with almost the same type of processing method as described above by preliminarily converting the PCM data into the ADPCM data in the RAM 12.

The operation input unit 5 is mainly made up of an operation information interface circuit 18, an interface circuit 19, and a pointing signal receiving unit 29. The controller 25 is connected to the operation information interface circuit 18, and the interface circuit 19 is connected to the operation information interface circuit 18. The pointing signal receiving unit 29 serves to receive a signal from a pointing device 27 to be described. The interface circuit 19 is connected to the pointing signal receiving unit 29. In addition, the bus 6 is connected to the interface circuit 19.

The controller 25 is an operating device used by a game player for the purpose of inputting a variety of operating commands, and transmits an operating signal to the CPU 7 depending on a game player's operation. Also, a pointing device 27 is embedded in the controller 25.

For example, a piezo resistance sensor, a capacitance sensor, a magnetic sensor, and the like are included in the category of the acceleration sensor 24. When the controller 25 is moved, magnitude of acceleration of the controller 25 is measured and outputted by the acceleration sensor 24 of this type depending on movement of the controller 25. The acceleration sensor 24, which is herein used, is a triaxial acceleration sensor, and magnitude of accelerations in the triaxial directions are measured and outputted by the acceleration sensor 24 depending on movement of the controller 25. In other words, when the controller 25 is moved, magnitudes of accelerations in the triaxial directions from the acceleration sensor 24 are outputted as the acceleration data from the controller 25 to the operation input unit 5. It is possible to cause the control unit 1 to recognize movement of the controller 25 in the three-dimensional space by causing the control unit 1 to recognize and process the acceleration data.

The pointing device 27 is embedded in the tip of the controller. When the controller 25 is moved while the pointing device 27 is directed toward the pointing signal receiving unit 29, it is possible to cause an object displayed on the television monitor 20 to move. In other words, when an initial signal outputted from the pointing device 27 is inputted into the pointing signal receiving unit 29, a position coordinate of a target object of the pointing device 27 is recognized by the control unit 1. Then, when the controller 25 is moved, a second signal from the pointing device 27 is inputted into the pointing signal receiving unit 29, and displacement of the target object from the position coordinate, which corresponds to displacement of the controller 25, is calculated by the control unit 1. Then, the object is caused to move on the television monitor 20 by the command from the control unit 1 depending on the displacement of the target object.

Also, the controller 25 is provided with, for instance, a cross-shaped direction key made up of an up key 17U, a down key 17D, a left key 17L, and a right key 17R. For example, it is possible to move a character, an object, and a cursor on the screen of the television monitor 20 up, down, left, and right by the manipulation of the up key 17U, the down key 17D, the left key 17L, and the right key 17R. When the up key 17U, the down key 17D, the left key 17L, and the right key 17R are respectively manipulated, an operating signal corresponding to each of the keys is outputted from the controller 25 to the operation input unit 5, and a command corresponding to the operating signal is recognized by the control unit 1.

Note that each button and each key provided in the controller 25 are configured to function as ON/OFF switches that become an on-state when pressed from the neutral position by the external pressure and become an off-state by returning to the neutral position when the pressure is released.

The general operations of the home video game device configured as described above will be hereinafter explained. If a power switch (not illustrated in the figure) is turned on and accordingly the game system 1 is powered on, the CPU 7 reads out the image data, the audio data, and the program data from the recording medium 10 based on the operating system stored in the recording medium 10. All or part of the read-out data including the image data, the audio data, and the program data are stored in the RAM 12. Then, the CPU 7 issues commands to the image data and the audio data, both of which are stored in the RAM 12, based on the program data stored in the RAM 12.

In the case of the image data, the signal processor 8 firstly performs the positional computation, the light source computation, and the like for a character in the three-dimensional space based on the command from the CPU 7. Next, the image processor 9 performs a processing of writing the image data to be rendered to the RAM 12 based on the computation results by the signal processor 8. Then, the image data written to the RAM 12 is provided to the D/A converter 17 through the interface circuit 13. Here, the image data is converted into an analog image signal by the D/A converter 17. Then, the image data is provided to the television monitor 20 and is displayed as an image.

In the case of the audio data, the signal processor 8 firstly performs processing to generate and process the audio data based on the command from the CPU 7. Here, processing, such as the pitch conversion, the noise addition, the envelope setting, the level setting, and the reverb addition, is performed for the audio data. Next, the audio data is outputted from the signal processor 8 and is provided to the D/A converter 15 through the interface circuit 16. Here, the audio data is converted into an analog audio signal. Then, the audio data is outputted as the audio from the speaker 13 through the amplifier circuit 14.

### Summary of a Variety of Processing in Game Device

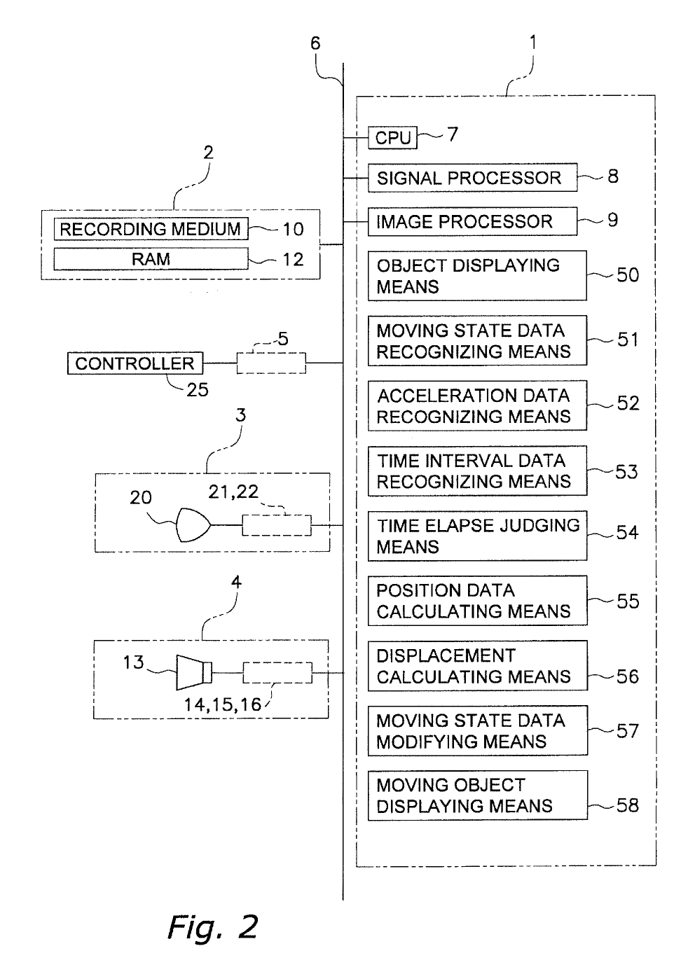

A game executed in a present game consol 1 is a baseball game, for instance. The present game console 1 is configured to be capable of executing a video game in which a moving object is displayed on the television monitor 20 of the image display unit 3 and a moving state of the moving object is controlled based on the acceleration data detected by the acceleration sensor 24 when the controller 25 in which the acceleration sensor 24 is embedded is moved. FIG. 2 is a functional block diagram for illustrating functions that play major roles in the present invention.

Object displaying means 50 has a function of displaying an object on the television monitor 20 of the image display unit 3 with the image data corresponding to the object. In the object displaying means 50, the object is displayed on the television monitor 20 of the image display unit 3 with the image data corresponding to the object.

Moving state data recognizing means 51 has a function of causing the control unit 1 to recognize the moving state data for setting a moving state of a moving object. In the moving state data recognizing means 51, the moving state data for setting the moving state of the moving object is recognized by the control unit 1.

Acceleration data recognizing means 52 has a function of causing the control unit 1 to recognize the acceleration data to be consecutively inputted into the input unit from the controller. In the acceleration data recognizing means 52, the acceleration data to be consecutively inputted into the input unit from the controller is recognized by the control unit 1. Specifically, the acceleration data recognizing means 52 causes the control unit 1 to judge whether or not a value of the acceleration data recognized by the control unit 1 is greater than or equal to a predetermined value. If it is judged by the control unit 1 that the value of the acceleration data recognized by the control unit 1 is greater than or equal to the predetermined value, the acceleration data is recognized by the control unit 1. In this case, if it is judged by the control unit 1 that the acceleration data recognized by the control unit 1 is greater than or equal to the predetermined value, the acceleration data is configured to be recognized by the control unit 1. Therefore, even when a game player slightly moves the controller, it is possible to prevent an object such as a pitcher character from starting a pitching motion in conjunction with movement of the controller. In other words, it is possible to prevent an error manipulation that is caused when a game player involuntarily moves the controller.

Time duration data recognizing means 53 has a function of causing the control unit 1 to recognize time duration of the acceleration data to be consecutively inputted into the input unit from the controller as the time duration data. In the time duration data recognizing means 53, the time duration of the acceleration data to be consecutively inputted into the input unit from the controller is recognized by the control unit 1 as the time duration data.

Time elapse judging means 54 has a function of causing the control unit 1 to judge whether or not a predetermined period of time is elapsed from the recognition starting time of the acceleration data recognized by the control unit 1. In the time elapse judging means 54, it is judged by the control unit 1 whether or not the predetermined period of time is elapsed from the recognition starting time of the acceleration data recognized by the control unit 1.

Position data calculating means 55 has a function of causing the control unit 1 to calculate the position data of the controller based on the acceleration data and the time duration data, both of which are recognized by the control unit 1. In the position data calculating means 55, the position data of the controller is calculated by the control unit 1 based on the acceleration data and the time duration data, both of which are recognized by the control unit 1. Specifically, in the position data calculating means 55, when it is judged by the control unit 1 that a predetermined period of time is elapsed from the recognition starting time of the acceleration data recognized by the control unit 1, the position data of the controller is calculated by the control unit 1 based on the acceleration data and the time duration data, both of which are recognized by the control unit 1 within a predetermined period of time. More specifically, in the position data calculating means 55, when it is judged by the control unit 1 that a predetermined period of time is elapsed from the recognition starting time of the acceleration data recognized by the control unit 1, the velocity magnitude (speed) data of the controller 25 is calculated by the control unit 1 by causing the control unit 1 to perform the integral calculation for the acceleration data recognized by the control unit 1 within a predetermined period of time with the time duration data. Then, the position data of the controller 25 is calculated by causing the control unit 1 to perform the integral calculation for the velocity magnitude data with the time duration data.

Displacement calculating means 56 has a function of causing the control unit 1 to calculate the changing amount of the controller based on the position data of the controller. In the displacement calculating means 56, the changing amount of the controller is calculated by the control unit 1 based on the position data of the controller. Specifically, the vertical displacement and the horizontal displacement of the controller are calculated by the control unit 1 based on the initial position coordinate and the final position coordinate of the position data calculated by the position data calculating means 55 within a predetermined period of time. Here, the vertical displacement and the horizontal displacement of the controller are calculated by the control unit 1 by calculating difference between the final position coordinate and the initial position coordinate of the position data in the three-dimensional real space that is a space in which the controller 25 is moved.

Moving state data modifying means 57 has a function of causing the control unit 1 to modify the moving state data depending on the changing amount of the controller. In the moving state data modifying means 57, the moving state data is modified by the control unit 1 depending on the changing amount of the controller. Specifically, in the moving state data modifying means 57, the moving velocity data for setting the moving velocity of the moving object is modified by the control unit 1 depending on the vertical displacement of the controller. Also, in the moving state data modifying means 57, the changing amount data for setting the changing amount of the moving object is modified by the control unit 1.

Moving object displaying means 58 has a function of displaying the moving object on the television monitor 20 of the image display unit 3 with the image data corresponding to the moving object based on the moving state data. In the moving object displaying means 58, a moving state of the moving object is consecutively displayed on the television monitor 20 of the image display unit 3 with the image data corresponding to the moving object based on the moving state data.

### Summary of Control System of Pitched Ball in Baseball Game and Flow of a Variety of Processing

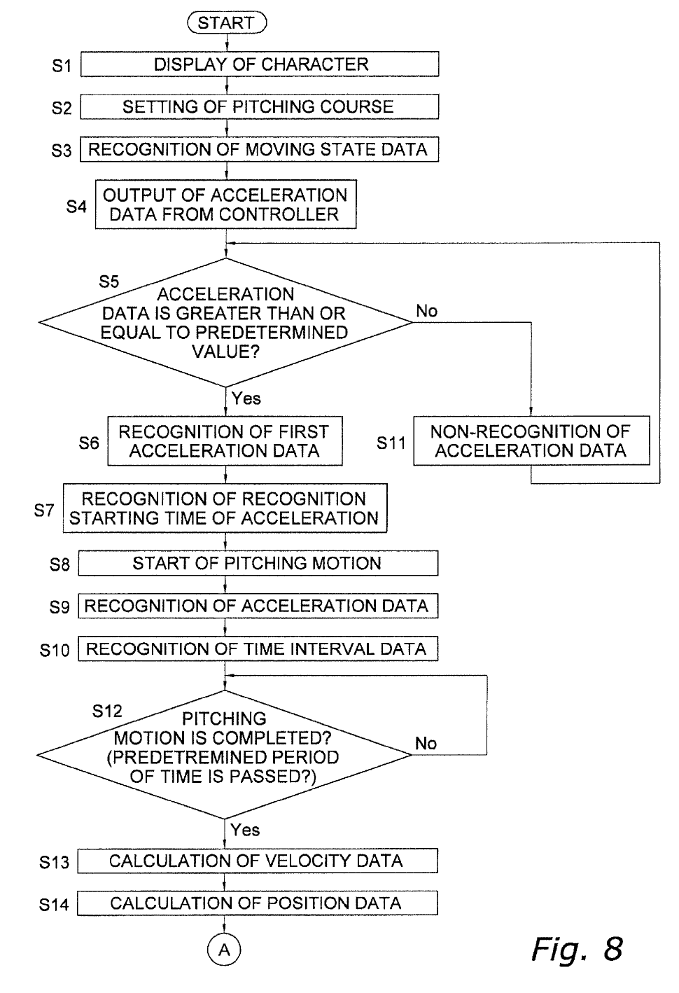

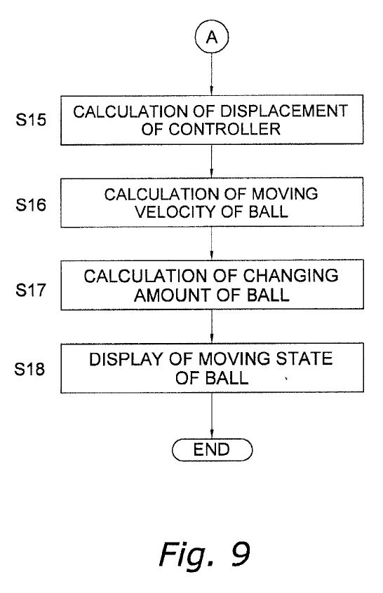

A control system of a pitched ball in the baseball game will be hereinafter explained. In addition, flow of the control system of the pitched ball illustrated in FIG. 8 will be simultaneously explained.

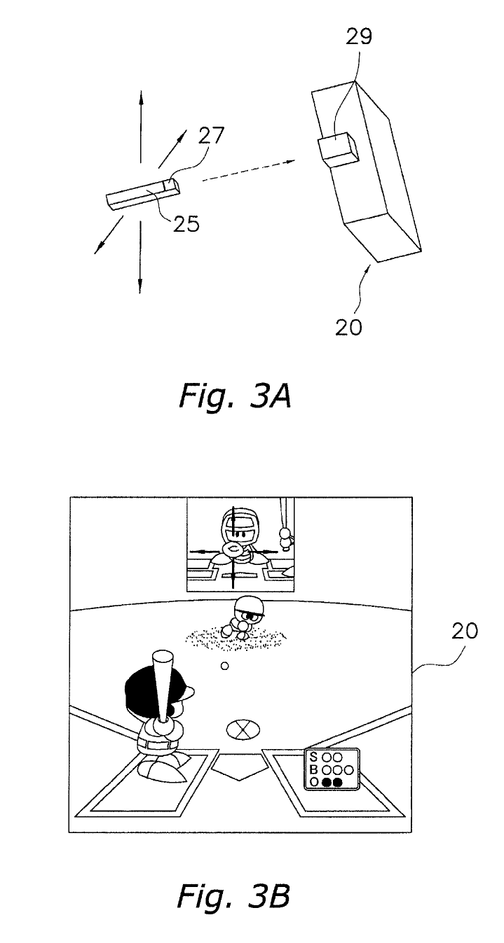

As illustrated in FIG. 3, when a game player operates a pitcher character in the present baseball game, a pitcher character 71, a batter character 72, and a catcher character 73 are displayed on the television monitor 20 (S1). Note that a case is hereinafter exemplified that the pitcher character 71 is a right-handed pitcher.

First, when the controller 25 is moved up, down, left, and right, a signal outputted from the pointing device 27 of the controller 25 is inputted into the pointing signal receiving unit 29, and displacement of the controller 25 is recognized by the control unit 1. Accordingly, the position of the mitt of the catcher character 73 is caused to move by the control unit 1 depending on the displacement of the controller 25, and the coordinate corresponding to the position of the mitt of the catcher character 73 is recognized by the control unit 1 (S2). In other words, a game player is capable of causing the control unit 1 to recognize the pitching course by moving the controller 25. Note that the catcher character 73 is being displayed on the upper part of the television monitor 20. However, the coordinate of the pitching course corresponding to the herein described mitt position is configured to move in conjunction with movement of the mitt position and is configured to move on the y-z plane in a predetermined position (predetermined x coordinate position) on the front side from the home plate in the game space.

Subsequently, when the cross-shaped direction key is operated, the initial moving state data corresponding to a pitch that is assigned to each of the keys 17U, 17D, 17L, and 17R is recognized by the control unit 1 (S3). The moving state data is made up of the moving velocity data for setting the moving velocity of the ball character 74 and the changing amount data for setting the changing amount of the ball character 74. The moving velocity data and the changing amount data are preliminarily set in the game program. Note that a fastball is assigned to the up key 17U, a forkball is assigned to the down key 17D, a screwball is assigned to the right key 17R, and a curveball is assigned to the left key 17L. When a game player presses the cross-shaped direction key, the initial moving state data corresponding to the pitch that is assigned to each of the keys 17U, 17D, 17L, and 17R is recognized by the control unit 1.

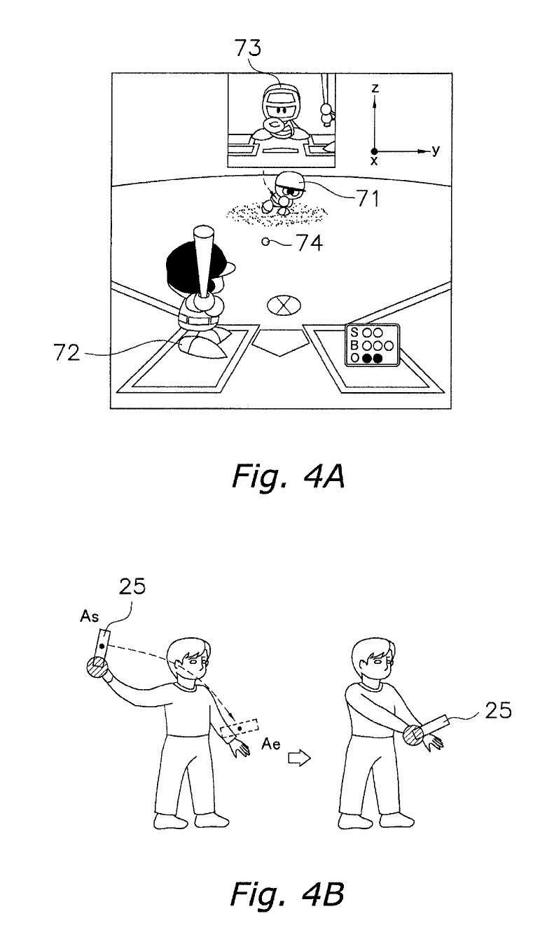

Next, as illustrated in FIG. 4, when the controller is moved as if a pitcher threw a ball, acceleration data G detected by the acceleration sensor 24 embedded in the controller 25 is consecutively outputted from the controller 25 to the operation input unit 5, and is inputted into the operation input unit 5 (S4). Accordingly, it is judged by the control unit 1 whether or not the absolute value of the acceleration data G inputted into the operation input unit 5 is greater than or equal to a predetermined value (S5). Then, if it is judged by the control unit 1 that the absolute value of the acceleration data G is greater than or equal to the predetermined value (Yes in S5), the initial acceleration data is recognized by the control unit 1 (S6). Here, the recognition starting time of the acceleration data is recognized by the control unit 1 (S7). Accordingly, a command for causing the pitcher character 71 to start a pitching motion is issued by the control unit 1 (S8). Then, the subsequent acceleration data G succeeding the initial acceleration data is sequentially recognized by the control unit 1 (S9). Also, here, time duration of the acceleration data G to be consecutively inputted into the operation input unit 5 is recognized by the control unit 1 as time duration data dt (S10). On the other hand, if it is judged by the control unit 1 that the absolute value of the acceleration data G inputted into the operation input unit 5 is less than a predetermined value (No in S5), the acceleration data G is not recognized by the control unit 1 (S11). In other words, a command for causing the pitcher character 71 to start a pitching motion is not issued by the control unit 1.

Subsequently, it is judged by the control unit 1 whether or not a predetermined period of time has been elapsed from the recognition starting time of the acceleration data firstly recognized by the control unit 1 (S12). Specifically, it is judged by the control unit 1 whether or not a predetermined period of time spent for completing the pitching motion of the pitcher character has been elapsed. Note that the herein described predetermined period of time corresponds to a period of time in which the pitcher starts a pitching motion and then releases a ball. The predetermined period of time is preliminarily set in the game program.

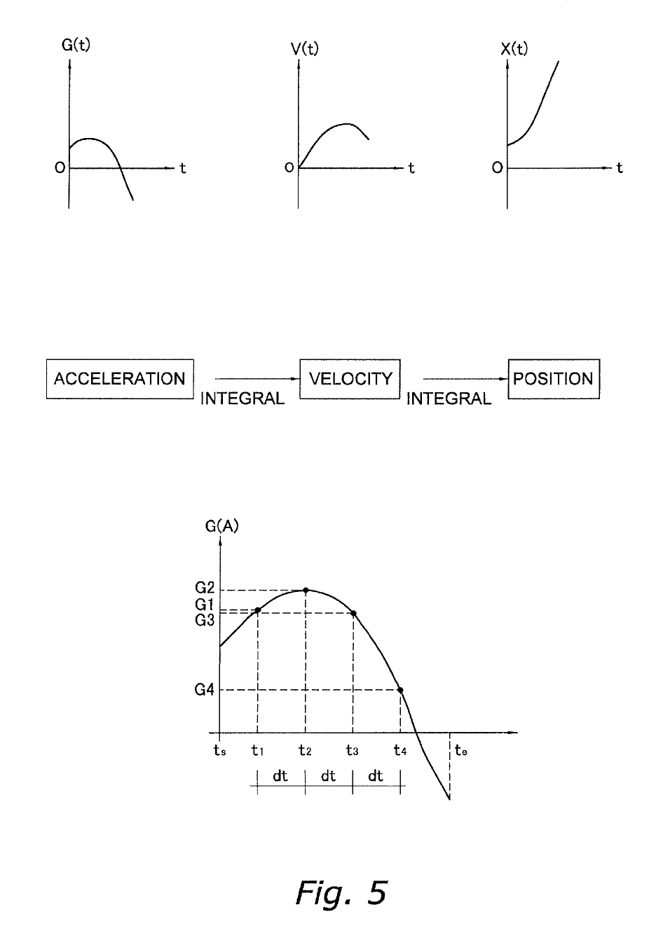

Then, if it is judged by the control unit 1 that a predetermined period of time is elapsed from the recognition starting time (Yes in S12), as illustrated in FIG. 5, the integral calculation is performed for the acceleration data G recognized by the control unit 1 within the predetermined period of time by the control unit 1 with the time duration data dt, and velocity magnitude data V of the controller 25 is calculated by the control unit 1 (S13). Also, the integral calculation is performed for the velocity magnitude data V of the controller 25 by the control unit 1 with the time duration data dt, and position data X of the controller 25 is calculated by the control unit 1 (S14).

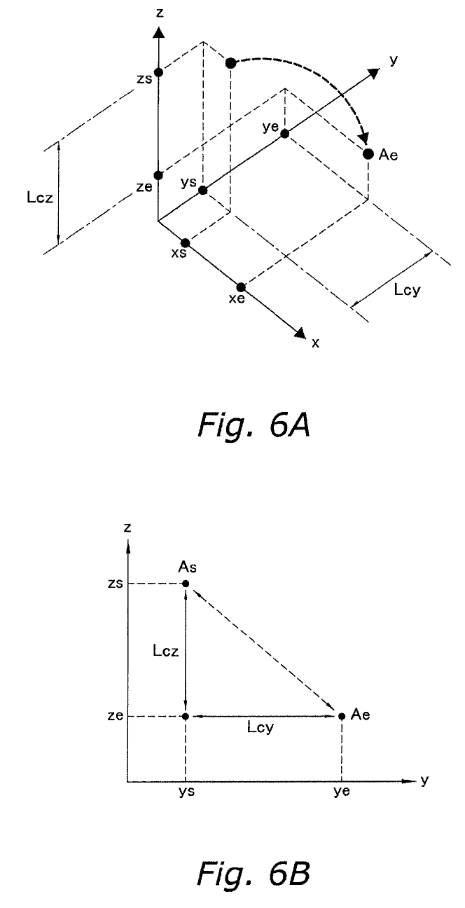

Subsequently, the vertical displacement and the horizontal displacement of the controller are calculated by the control unit 1 based on the initial position coordinate and the final position coordinate of the position data X of the controller 25 calculated within the predetermined period of time (S15). Specifically, the vertical displacement of the controller is calculated by the control unit 1 by causing the control unit 1 to perform the calculation of subtracting the value of the z-coordinate of the final position coordinate of the controller 25 at the time when the predetermined period of time is elapsed from the recognition starting time, from the value of the z-coordinate of the initial position coordinate of the controller 25 at the recognition starting time. Also, the horizontal displacement of the controller is calculated by the control unit 1 by causing the control unit 1 to perform the calculation of subtracting the value of the y-coordinate of the initial position coordinate of the controller 25 at the recognition starting time from the value of the y-coordinate of the final position coordinate of the controller 25 at the time when the predetermined period of time is elapsed from the recognition starting time (see FIG. 6).

Accordingly, the moving velocity data for setting the moving velocity of the ball character 74 is modified by the control unit 1 depending on the vertical displacement of the controller (S16). Then, the changing amount data for setting the changing amount of a breaking ball of the ball character 74 is modified by the control unit 1 depending on the horizontal displacement of the controller (S17). Accordingly, the calculation of dividing the changing amount set by the modified changing amount data of the breaking ball by the number of frames during which the moving ball character 74 is being displayed on the television monitor 20 is performed by the control unit 1, and the changing amount of the breaking ball per unit frame is calculated by the control unit 1. Then, the calculation of dividing the display period of time during which the moving ball character 74 is being displayed on the television monitor 20 by the number of frames is performed by the control unit 1, and the display period of time per unit frame is calculated by the control unit 1. Note that the display period of time during which the moving ball character 74 is being displayed on the television monitor 20 is preliminarily set in the game program with respect to each of pitches.

Accordingly, a state of the ball character 74 moving based on the moving state data made up of the modified moving velocity data and the modified changing amount data is consecutively displayed on the television monitor 20 of the image display unit 3 with the image data corresponding to the ball (S19). Specifically, the image data corresponding to the ball, such as the two-dimensional image data or the polygon data, is caused to move in a direction that a breaking ball changes by the changing amount per unit frame after it is displayed for the display period of time per unit frame. Thus, a state that the ball character 74 released by the pitcher character moves toward the catcher character by the modified changing amount is displayed on the television monitor 20 of the image display unit 3. Note that if a fastball is instructed as a pitch when the up key 17U of the cross-shaped direction key is pressed, the above described changing amount data of the ball character 74 is not modified and only the moving velocity data is modified, and a moving state of the ball character 74 is consecutively displayed on the television monitor 20 of the image display unit 3 with the image data corresponding to the ball based on the modified moving velocity data.

Contents of Processing for each Means in Control System of Pitched Ball in Baseball Game and Supplementary Explanation Thereof

### Position Data Calculating Means

When the acceleration data G made up of magnitudes of the accelerations in the triaxial directions is recognized by the control unit 1 and then time duration of the acceleration data G (gx, gy, gz, t) consecutively inputted into the operation input unit 5 from the controller 25 is recognized by the control unit 1 as the time duration data dt, as illustrated in FIG. 5, the integral calculation is performed by the control unit 1 for the acceleration data G consecutively inputted into the operation input unit 5 from the controller 25 with the time duration data dt, and the velocity magnitude data V (vx, vy, vz, t) of the controller 25 in the triaxial directions is calculated by the control unit 1. For example, when acceleration data G1 (gx1, gy1, gz1, t1) is firstly recognized by the control unit 1 at time t1 and subsequently acceleration data G2 (gx2, gy2, gz2, t2) is recognized by the control unit 1 at time t2, velocity magnitude data V1 (vx1, vy1, vz1, t1) of the controller 25 is calculated by the control unit 1 by causing the control unit 1 to perform the calculation of “∫ [G2(gx2, gy2, gz2, t2)−G1(gx1, gy1, gz1, t1)]·dt” between the time t2 and the time t1. In a similar way to the above, when acceleration data G3 (gx3, gy3, gz3, t3) is recognized by the control unit 1 at time t3 succeeding the time t2, velocity magnitude data V2 (vx2, vy2, vz2, t2) of the controller 25 is calculated by the control unit 1 by causing the control unit 1 to perform the calculation of “∫ [G3(gx3, gy3, gz3, t3)−G2(gx2, gy2, gz2, t2)]·dt” between the time t3 and the time t2. Also, when acceleration data G4 (gx4, gy4, gz4, t4) is recognized by the control unit 1 at time t4 succeeding the time t3, velocity magnitude data V3 (vx3, vy3, vz3, t3) of the controller 25 is calculated by the control unit 1 by causing the control unit 1 to perform the calculation of “∫ [G4(gx4, gy4, gz4, t4)−G3(gx3, gy3, gz3, t3)]·dt” between the time t4 and the time t3.

When the integral calculation is further performed by the control unit 1 for thus calculated velocity magnitude data V of the controller 25 with the time duration data dt, the position data X of the controller 25 is calculated by the control unit 1. For example, position data X1 (x1, y1, z1, t1) of the controller 25 is calculated by the control unit 1 by causing the control unit 1 to perform the calculation of “∫ [V2(vx2, vy2, vz2, t2)−V1(vx1, vy1, vz1, t1)]·dt” between the time t2 and the time t1. In a similar way to this, position data X2 (x2, y2, z2, t2) of the controller 25 is calculated by the control unit 1 by causing the control unit 1 to perform the calculation of “∫ [V3(vx3, vy3, vz3, t3)−V2(vx2, vy2, vz2, t2)]·dt” between the time t3 and the time t2.

It is possible to calculate the velocity magnitude data and the position data of the controller 25 in each time based on the acceleration data G of the controller 25 by causing the control unit 1 to perform a series of calculations as described above when the acceleration data G of the controller 25 is recognized by the control unit 1.

Note that in calculating the above described velocity magnitude data V and the above described position data X of the controller 25, time ts at which the acceleration data G of the controller 25 is firstly recognized by the control unit 1 is set to be the recognition starting time. Also, time te at which a predetermined period of time is elapsed from the recognition starting time is set to be the recognition ending time.

### Moving State Data Modifying Means

As illustrated in FIG. 6, when a game player performs a throwing motion as if he/she were a pitcher while he/she holds the controller with his/her hand, an initial position coordinate As (xs, ys, zs, ts) of the controller 25 and a final position coordinate Ae (xe, ye, ze, te) of the controller 25 are calculated by the control unit 1 in the position data calculating means. Displacement Lc of the controller 25 (|As−Ae|=(|xs−xe|, |ys−ye|, |zs−ze|)) is calculated by the control unit 1 by calculating difference between the initial position coordinate As and the final position coordinate Ae based on the initial position coordinate As and the final position coordinate Ae. Thus, when vertical displacement Lcz (=zs−ze) of the controller 25 and horizontal displacement Lcy (=ye−ys) of the controller 25 are calculated by the control unit 1, the moving velocity data for setting the moving velocity of the ball character 74 and the changing amount data for setting the changing amount of the ball character 74 are modified by the control unit 1 depending on the vertical displacement Lcz and the horizontal displacement Lcy of the controller.

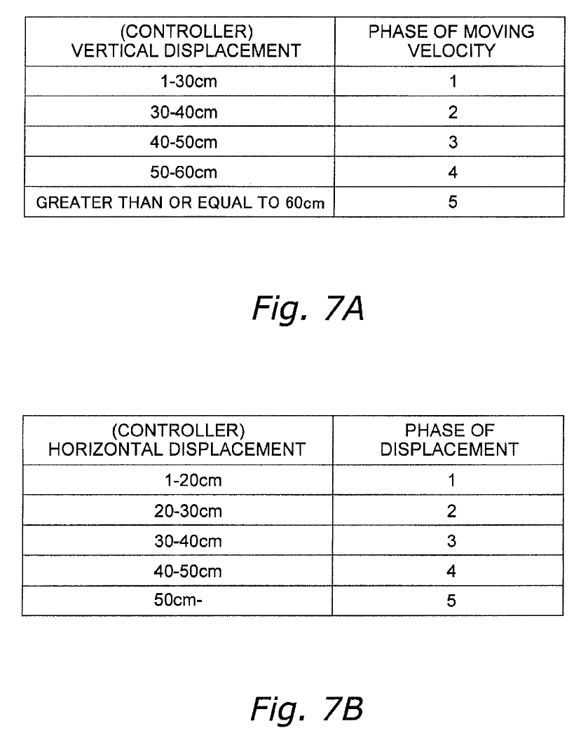

For example, when the moving velocity of the ball character 74 is configured to change in five phases (1-5), the moving velocity data for setting the moving velocity of the ball character 74 is modified by the control unit 1 based on, for instance, a correspondence table illustrated in FIG. 7. Specifically, when it is judged by the control unit 1 that the vertical displacement Lcz of the controller 25 falls in the range of 1-30 cm, the moving velocity of the ball character 74 corresponding to the phase 1 is selected by the control unit 1. When it is judged by the control unit 1 that the vertical displacement Lcz falls in the range of 30-40 cm, the moving velocity corresponding to the phase 2 is selected by the control unit 1. When it is judged by the control unit 1 that the vertical displacement Lcz falls in the range of 40-50 cm, the moving velocity corresponding to the phase 3 is selected by the control unit 1. Also, when it is judged by the control unit 1 that the vertical displacement Lcz of the controller 25 falls in the range of 50-60 cm, the moving velocity of the ball character 74 corresponding to the phase 4 is selected by the control unit 1. When it is judged by the control unit 1 that the vertical displacement Lcz is greater than or equal to 60 cm, the moving velocity of the ball character 74 corresponding to the phase 5 is selected by the control unit 1. Here, the moving velocity of the ball character 74 corresponding to the phase 1 corresponds to the minimum moving velocity, and the moving velocity of the ball character 74 corresponding to the phase 5 corresponds to the maximum moving velocity. The moving velocity data for setting the minimum moving velocity and the maximum moving velocity is preliminarily set with respect to each of pitches in the game program.

For example, when the changing amount of the breaking ball of the ball character 74 is configured to change in five phases (1-5), the displacement data for setting the displacement of the ball character 74 is modified by the control unit 1 based on, for instance, a correspondence table illustrated in FIG. 7. Specifically, when it is judged by the control unit 1 that the horizontal displacement Lcy of the controller 25 falls in the range of 1-20 cm, the displacement of the ball character 74 corresponding to the phase 1 is selected by the control unit 1. When it is judged by the control unit 1 that the horizontal displacement Lcy falls in the range of 20-30 cm, the displacement corresponding to the phase 2 is selected by the control unit 1. When it is judged by the control unit 1 that the horizontal displacement Lcy falls in the range of 30-40 cm, the displacement corresponding to the phase 3 is selected by the control unit 1. Also, when it is judged by the control unit 1 that the horizontal displacement Lcy of the controller 25 falls in the range of 40-50 cm, the displacement of the ball character 74 corresponding to the phase 4 is selected by the control unit 1. When it is judged by the control unit 1 that the horizontal displacement Lcy is greater than or equal to 50 cm, the displacement of the ball character 74 corresponding to the phase 5 is selected by the control unit 1. Here, the displacement of the ball character 74 corresponding to the phase 1 corresponds to the minimum displacement, and the displacement of the ball character 74 corresponding to the phase 5 corresponds to the maximum displacement. The displacement data for setting the minimum displacement and the maximum displacement is preliminarily set with respect to each of pitches in the game program.

Based on the above, as the vertical displacement of the controller 25 becomes greater, it is accordingly possible to increase the moving velocity of the ball character 74. Also, as the horizontal displacement of the controller 25 becomes greater, it is accordingly possible to increase the changing amount of the breaking ball.

Note that a case is herein exemplified that the moving velocity corresponding to the phases of the moving velocity of the ball character 74 is selected by the control unit 1 based on the correspondence relation between the vertical displacement Lcz of the controller and the phases of the moving velocity of the ball character 74. However, the moving velocity of the ball character 74 may be configured to be directly calculated from the vertical displacement Lcz of the controller under the condition that a correspondence table indicating correspondence between the vertical displacement Lcz of the controller and the moving velocity of the ball character 74 is preliminarily created. Also, a case is exemplified that the displacement of the breaking ball corresponding to the phases of the displacement of the ball character 74 is selected by the control unit 1 based on the correspondence relation between the horizontal displacement Lcy of the controller and the phases of the displacement of the breaking ball of the ball character 74. However, the displacement of the breaking ball of the ball character 74 may be configured to be directly calculated from the horizontal displacement Lcy of the controller under the condition that a correspondence table indicating correspondence between the horizontal displacement Lcy of the controller and the displacement of the ball character 74 is preliminarily created.

### Other Embodiments

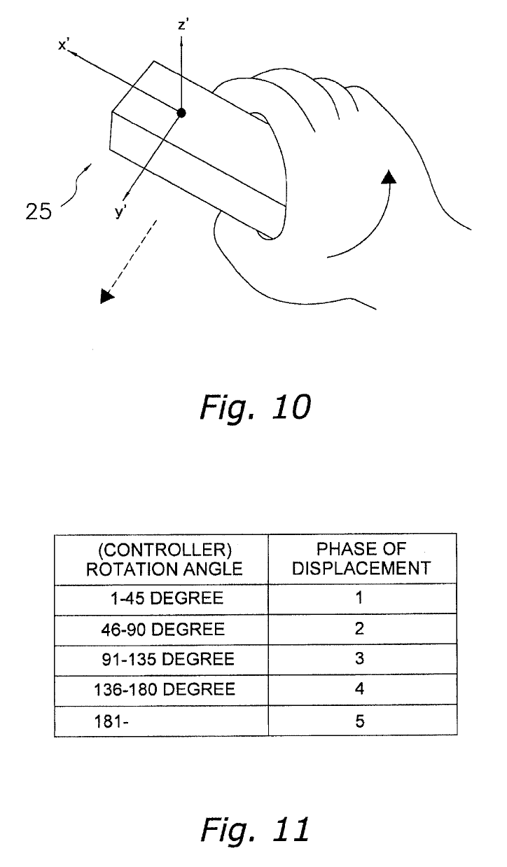

(a) In the above described embodiment, a case is exemplified that the displacement of the ball character 74 is calculated based on the position data of the controller 25. However, the displacement of the ball character 74 may be configured to be calculated based on the angle data of the controller 25. For example, as illustrated in FIG. 10, the control unit 1 is configured to be caused to calculate the rotation angle of the controller based on the acceleration data to be outputted from the controller 25, such as the angular acceleration data around an axis x′ when a game player performs a throwing motion as if he/she is a pitcher while he/she holds the controller 25 with his/her hand. In this case, the integral calculation is performed for the angular acceleration data around the axis x′ by the control unit 1 under a condition that the relation illustrated in FIG. 5 is applied to the angular acceleration, and the angular velocity data around the axis x′ is calculated by the control unit 1. Then, the integral calculation is again performed for the angular velocity data by the control unit, and the angle data for setting the rotation angle around the axis x′ is calculated by the control unit 1. Next, for example, as illustrated in FIG. 11, when the changing amount of the ball character 74 is configured to change in five phases (1-5), each of the phases corresponding to the angle around the axis x′ is recognized by the control unit 1 based on, for instance, the correspondence table illustrated in FIG. 7, and the changing amount of the ball character 74 corresponding to each of the phases is recognized by the control unit 1. Note that the changing amount of the ball character 74 corresponding to each of the phases is preliminarily set in the game program. Then, a moving state of the ball character 74 is displayed on the television monitor 20 of the image display unit 3 with the image data corresponding to the ball character 74 based on the changing amount data corresponding to the changing amount of the recognized ball character 74. Note that the moving velocity of the ball character 74 in this case is calculated by the control unit 1 in almost the same way as the above described embodiment.

(b) In the above described embodiment, a case is exemplified that the home video game device is used as an example of a computer to which the game program is allowed to be applied. However, the game device is not limited to the above described embodiment. The present invention may be applied to a game device for which a monitor is separately provided, a monitor-integrated game device, a personal computer or a workstation that functions as a game device when a game program is executed therein, and the like, as well. (c) A program for executing the above described game and a computer-readable recording medium in which the program is recorded are also included in the present invention. For example, a computer-readable flexible disk, a semiconductor memory, a CD-ROM, a DVD, a MO, a ROM cassette, and the like may be suggested as the recording medium other than the cartridge.

### INDUSTRIAL APPLICABILITY

According to the present invention, it is possible to display an object on an image display unit and to control a moving state of an object based on the acceleration data detected by an acceleration sensor when a controller in which the acceleration sensor is embedded is moved.

The terns of degree such as “substantially”, “about” and “approximately” as used herein mean a reasonable amount of deviation of the modified term such that the end result is not significantly changed. These terms should be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A computer readable medium storing a computer program for a video game which a user plays by moving an input device, the computer program comprising:
code for recognizing moving state of the moving object;
code for recognizing acceleration of the input unit;
code for recognizing time duration of the acceleration;
code for calculating at least either a position of the input unit or an angle of the input unit based on the acceleration and the time duration;
code for calculating change of the position of the input unit on the basis of at least either the position or the angle of the input unit;
code for modifying the moving state to modified moving state on the basis of the change; and
code for displaying the moving object on the image display unit on the basis of the modified moving state.

2. The computer readable medium according to claim 1, the computer program further comprising
code for calculating speed of the moving object, and
code for modifying the speed of the moving object on the basis of the change of the position of the input device.

3. The computer readable medium according to claim 2, wherein
the code for modifying the speed of the moving object on the basis of the change of the position of the input device, includes code for modifying the speed of the moving object on the basis of vertical change of the position of the input device.

4. The computer readable medium according to claim 1, the computer program further comprising
code for modifying the change of the position of the moving object on the basis of change of the position of the input device.

5. The computer readable medium according to claim 4, wherein
the code for modifying the change of the position of the moving object on the basis of the position of the input device, includes code for modifying the change of the moving object on the basis of the change of the input device in a direction crossover to the vertical direction.

6. The computer readable medium according to claim 4, wherein
the code for modifying the change of the position of the moving object on the basis of the position of the input device, includes code for modifying the change of the moving object on the basis of the change of the input device in a rotational direction.

7. The computer readable medium according to claim 1, the computer program further comprising
code for judging whether or not a predetermined period of time is elapsed after the acceleration is recognized, and
wherein at least either the position of the input unit or the angle of the input unit is calculated on the basis of the acceleration and the time duration, if the predetermined period is elapsed.

8. A game device of a video game which a user plays by moving an input device, the game device comprising:
a moving state data recognizing unit configured to recognize moving state of the moving object;
an acceleration data recognizing unit configured to recognize acceleration of the input unit;
a time duration data recognizing unit configured to recognize time duration of the acceleration;
a position data calculating unit configured to calculate at least either a position of the input unit or an angle of the input unit based on the acceleration and the time duration;
a changing amount calculating unit configured to calculate change of the position of the input unit on the basis of at least either the position or the angle of the input unit;
a moving state data modifying unit configured to modify the moving state to modified moving state on the basis of the change; and
a moving object displaying unit configured to display the moving object on the image display unit on the basis of the modified moving state.

9. A method for controlling a video game which a user plays by moving an input device, the method comprising:
recognizing moving state of the moving object;
recognizing acceleration of the input unit;
recognizing time duration of the acceleration;
calculating at least either a position of the input unit or an angle of the input unit based on the acceleration and the time duration;
calculating change of the position of the input unit on the basis of at least either the position or the angle of the input unit;
modifying the moving state to modified moving state on the basis of the change; and
displaying the moving object on the image display unit on the basis of the modified moving state.
